(19) United States
(12) Patent Application Publication
(10) Pub. No.: US 2015/0158989 A1
(43) Pub. Date: Jun. 11, 2015

(54) METHOD FOR CHEMICAL FOAMING IN THE PRESENCE OF REINFORCING FILLERS

(71) Applicants: RHODIA OPERATIONS, Paris (FR); CENTRE NATIONAL DE LA RECHERCHE SCIENTIFIQUE, Paris (FR)

(72) Inventors: Clio Cocquet, Mondonville (FR); Didier Long, Sainte Foy les Lyon (FR); Olivier Andres, Mions (FR); Vincent Curtil, Bron (FR); Lise Trouillet-Fonti, Villette-de-Vienne (FR)

(73) Assignees: RHODIA OPERATIONS, Paris (FR); CENTRE NATIONAL DE LA RECHERCHE SCIENTIFIQUE, Paris (FR)

(21) Appl. No.: 14/413,919

(22) PCT Filed: Jul. 12, 2013
(86) PCT No.: PCT/EP2013/064815

§ 371 Date: Jan. 9, 2015

(30) Foreign Application Priority Data
Jul. 12, 2012 (FR) 1256698

(51) Int. Cl. C08J 9/00; C08J 9/228

(52) U.S. Cl. CPC C08J 9/0004; C08J 9/228; C08J 9/0085; C08J 9/0061; C08J 2377/06; C08J 2375/04; C08J 2203/02

(57) ABSTRACT

The present invention relates to a method for preparing a foamed item, including the following steps: a) heating a composition including, or consisting of, at least one polyamide PA, at least one compound U including at least one urethane function, particularly a polyurethane PU, at least one reinforcing filler, the content of which is no lower than 10 wt % of the total weight of the composition, and temperature T such that: the compound U directly or indirectly generates CO₂, the polyamide is melted, and in particular, such that the composition is injectable; b) injecting or extruding said composition, the injection particularly being injection molding; and c) recovering the foamed item and an expandable granule including, or consisting of, at least one polyamide, at least one compound U, particularly a polyurethane PU, and at least one reinforcing filler, the content of reinforcing filler being no lower than 10 wt % of the total weight of the composition. The invention also relates to the use of such a composition of such a granule, or a foam or foamed item.

The present invention relates in particular to a foaming process which makes it possible to produce reinforced polyamide articles, to expandable granules comprising a polyamide, a compound comprising at least one urethane functional group known as compound U, and reinforcing fillers, to articles capable of being obtained by said process and to the use of these articles in various applications.

The application WO 2008/107313 describes the use of a composition comprising at least one polyamide matrix in the manufacture by injection of a microcellular article by molding using a fluid in the supercritical state. This document describes the production of microcellular articles reinforced with glass fibers. However, the installation of such a process requires modifications to the injection apparatus which are expensive and complex.

A process for the preparation of polyamide foam is described in the application WO2010/130686. This process is based on the heating of a mixture of polyamide and polyurethane. However, this process does not describe the production of reinforced foams, in particular via an injection molding process.

Furthermore, existing foaming processes can prove to be unsatisfactory, in particular in terms of:
ease of use.
flexibility of the shapes of articles which can be produced, in particular the production of articles of complex shapes,
degree of foaming, in particular in order to obtain a high degree of foaming,
control of the size of the bubbles, in particular in injection molding processes; quite often, the size of the bubbles is rather heterogeneous and/or is not in accordance with the desired size,
distribution of the bubbles in the final material,
production of articles having satisfactory, indeed even good or excellent, properties in terms of.
   thermal insulation,
   mechanical strength, in particular in temperature and/or with respect to the absorption of energy in the event of impact,
   resistance to solvents,
   water uptake,
   dimensional stability,
   surface appearance,
   shrinkage during shaping, and/or
   cost.
      very particularly, the processes of the prior art can be unsatisfactory in producing articles exhibiting a good compromise in some or all of these properties, very particularly coupled with a saving in weight.

In particular, the articles can exhibit good barrier properties, in particular toward water, toward gases and/or toward solvents, in particular fuels.

The invention can also make it possible to have a controlled size of the bubbles, while having a polyamide of relatively low viscosity, which can make possible good processability, in particular in injection molding.

The processes of the prior art can also prove to be insufficient in producing articles exhibiting a good compromise in at least two, in particular at least three, indeed even at least four, of the following properties:
thermal insulation,
resistance to solvents,
mechanical properties, such as flexural strength, impact strength and/or compressive strength, in particular in temperature,
reduction in weight,
absorption of energy in the event of impact,
density,
resistance to heat,
surface appearance, and
cost.

There thus exists a need for a process which makes it possible to solve, in all or part, the problems touched upon above. Very particularly, the invention is targeted at a process which is simultaneously simple to implement, which makes it possible in particular to use a minimum of components and/or which does not require or which requires few modifications to production lines, in particular with respect to injection devices and more particularly injection molding devices.

According to a first aspect, a subject matter of the invention is a process for the preparation of a foamed article comprising the following stages:
a) heating a composition comprising, indeed even consisting of:
   at least one polyamide PA,
   at least one compound U, said compound U comprising at least one urethane functional group, in particular a polyurethane PU,
   at least one reinforcing filler, the content of reinforcing fillers being greater than or equal to 10% by weight, with respect to the total weight of the composition, to a temperature T such that:
   the compound U generates, directly or indirectly, CO₂ and
   the polyamide is molten, and in particular the composition is injectable,
b) injecting or extruding said composition; in particular, the injection is an injection molding,
c) recovering the foamed article,
   very particularly, said composition is devoid of free isocyanates before heating. The composition does not generate CO₂ at ambient temperature; in particular, it does not generate CO₂ at a temperature of less than 100° C.

The term “foamed article” is understood to mean an article comprising a polymer matrix, which is the only continuous phase of the system, and gas present in the form of discrete bubbles.

According to another of its aspects, a subject matter of the invention is an expandable granule comprising, indeed even consisting of:
at least one polyamide,
at least one compound U, said compound U comprising at least one urethane functional group, in particular a polyurethane PU, and
at least one reinforcing filler, the content of reinforcing fillers being greater than or equal to 10% by weight, with respect to the total weight of the composition.

According to yet another of its aspects, a subject matter of the invention is the use of a composition or of an expandable granule according to the invention for the manufacture of a foamed article, in particular by injection molding.

According to yet another of its aspects, a subject matter of the invention is a foam or a foamed article capable of being obtained by the process according to the invention.

According to another of its aspects, a subject matter of the invention is the use of reinforcing fillers, in particular as defined in the present description, as agent which makes it possible to improve the control of the size of the bubbles present in a reinforced foamed article based on polyamide and on compound U, in particular polyurethane, especially obtained by a process as described in the present description.

This is because reinforcing fillers, in particular in the case of an injection molding process, can make it possible to control the size of the bubbles, even with polyamides of low viscosity, very particularly in the case of PA66 and PA6.

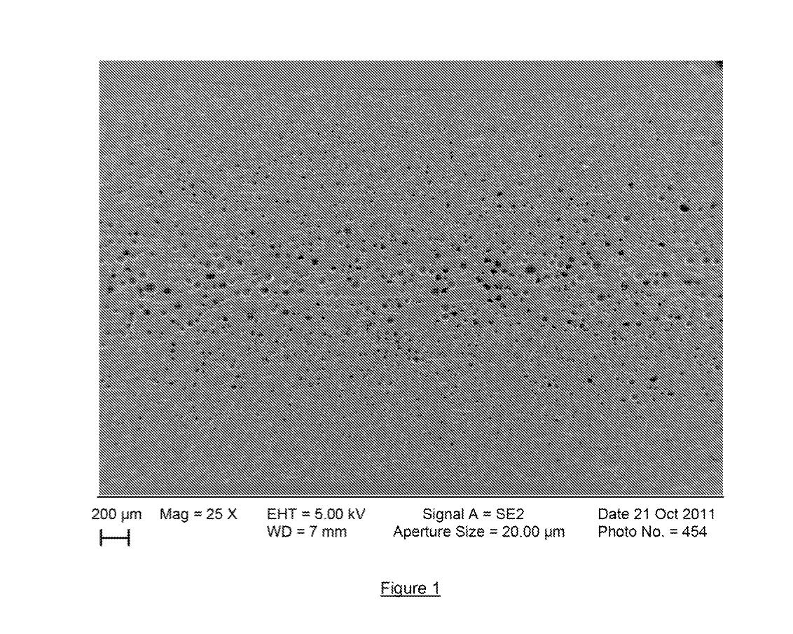

A scanning electron microscopy view in cross-section of the entire thickness of a foamed disk corresponding to test 1 is represented in FIG. 1 and makes it possible to see the population of the bubbles in a foamed article obtained according to the process of the invention.

The polyamide PA of the invention is a polyamide of the type of those obtained by polycondensation starting from dicarboxylic acids and diamines or of the type of those obtained by polymerization or polycondensation of lactams and/or amino acids. The polyamide of the invention can be a blend of polyamides of different types and/or of the same type, and/or of the copolymers obtained from different monomers corresponding to the same type and/or to different types of polyamide.

The polyamide PA of the invention advantageously exhibits a number-average molar mass Mn of greater than or equal to 10 000 g/mol, preferably of greater than or equal to 12 000 g/mol and more preferably still of greater than or equal to 14 000 g/mol.

The polyamide PA of the invention advantageously exhibits a number-average molar mass of less than or equal to 35 000 g/mol, preferably of less than or equal to 30 000 g/mol and more preferably still of less than or equal to 20 000 g/mol.

Thus, the polyamide according to the invention can exhibit a number-average molar mass ranging from 10 000 to 35 000 g/mol, in particular from 12 000 to 30 000 g/mol and especially from 14 000 to 20 000 g/mol.

The content of acid end groups CEG can be greater than the content of amine end groups AEG, in particular according to the relationship CEG>AEG+10 meq/kg, indeed even CEG>AEG+15 meq/kg. In particular, the content of acid end groups AEG is greater than or equal to 50 meq/kg.

Mention may be made, as examples of polyamides which may be suitable for the invention, of polyamide 6, polyamide 6,6, polyamide 11, polyamide 12, polyamide 4,6, polyamide 6,10, polyamide 10,10, polyamide 12,12, polyamide 10,12, polyamide 6,36 and their copolymers; semi-aromatic polyamides, in particular MXD6, polyphthalamides obtained from terephthalic acid and/or isophthalic acid, such as the polyamide sold under the Amodel trade name, and their copolyamides, such as copolyamide 66/6T or copolyamide 6T/6I, polyamides and copolyamides based on 6T, 9T and 10T, and their copolymers and alloys.

According to a preferred embodiment of the invention, the polyamide is chosen from polyamide 6, polyamide 6,6, their blends and copolymers. Advantageously, the polyamide is polyamide 6,6.

According to a specific alternative form of the invention, the polyamide PA of the invention is a linear polyamide.

According to another specific alternative form of the invention, the polyamide PA of the invention comprises star-branched or H-branched macromolecular chains and, if appropriate, linear macromolecular chains. The polymers comprising such star-branched or H-branched macromolecular chains are, for example, described in the documents FR2743077, FR2779730, U.S. Pat. No. 5,959,069, EP0632703, EP0682057 and EP0832149.

According to another specific alternative form of the invention, the polyamide PA of the invention is a copolyamide exhibiting a random tree structure. These copolyamides having a random tree structure and their process of production are described in particular in the document WO99/03909. According to a specific embodiment of the invention, the polyamide PA of the invention can be a polyamide of low viscosity, such as described in the document WO2008/107314.

The polyamide PA of the invention can also be a composition comprising a linear polyamide and, as additive, a star-branched, H-branched and/or tree polyamide as described above.

The polyamide PA of the invention can also be a composition comprising, as additive, a hyperbranched copolyamide of the type of those described in the document WO 00/68298.

The polyamide PA can optionally comprise other functional groups, such as ester, urea and/or ether functional groups.

The polyamide PA can be present in the composition in a content ranging from 20% to 89.9% by weight, in particular from 25% to 85% by weight, especially from 33% to 80% by weight or indeed even from 50% to 75% by weight, with respect to the total weight of the composition.

The compound U is in particular involved in the following reactions (in which R₃NH₂ and R₄COOH respectively represent the amine end groups and the carboxylic acid end groups of the polyamide):

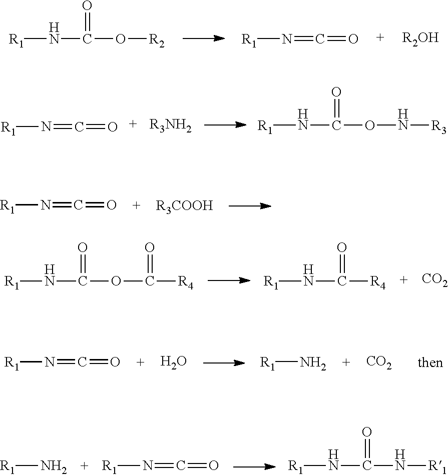

Thus, the CO₂ generated in this process can originate essentially, in particular at least to 80% by volume, especially at least to 85% by volume or indeed even at least to 90% by volume, from reactions involving, directly or indirectly, the compound U. In other words, the CO₂ can originate essentially or in large part from the urethane functional groups.

According to an alternative form, the process does not involve another route for the formation of CO₂ which has a significant contribution, that is to say a contribution of greater than 20% by volume, in particular 10% by volume, of the formation of the CO₂ during the process. For example, under certain conditions, CO₂ can originate from a thermal decomposition of the polyamide, in particular in the case of PA66.

In this process, the CO₂ generated by reactions involving, directly or indirectly, the compound U can represent a contribution of at least 80% by volume, in particular of at least 85% by volume and indeed even of at least 90% by volume, with respect to the total volume of gas included in the article obtained by the process.

In particular, the process does not involve another route for the formation of or for supplying gas which has a significant contribution, that is to say a contribution of greater than 20% by volume, in particular 10% by volume, with respect to the total volume of the gas included in the article obtained by the process.

The compound U comprises at least one urethane functional group. It can be a polyurethane, also known as PU, or a compound of the polyisocyanate blocked by an alcohol or a phenol type, which results in a urethane functional group. According to a specific embodiment, the compound U is a thermoplastic polyurethane.

Very particularly, the compound U and in particular the polyurethane PU generates isocyanate functional groups by decomposition of the urethane functional groups present in the main chain when heated, in particular to a temperature greater than the melting point of the polyamide.

In particular, the compound U and especially the polyurethane PU is devoid of isocyanate functional groups at ambient temperature, 25° C.

In the case where the compound U is a polyurethane PU, it can be obtained from a diisocyanate, from a polyol and optionally from a short-chain diol.

Examples of diisocyanates which can be used for the preparation of the polyurethane are isophorone diisocyanate, 1,3- and 1,4-cyclohexane diisocyanate, 1,2-ethylene diisocyanate, 1,4-tetramethylene diisocyanate, 1,6-hexamethylene diisocyanate, 2,2,4- and 2,4,4-trimethyl-1,6-hexamethylene diisocyanate, 1,12-dodecane diisocyanate, α,α′-diisocyanatodipropyl ether, 1,3-cyclobutane diisocyanate, 2,2- and 2,6-diisocyanato-1-methylcyclohexane, 2,5- and 3,5-bis(isocyanatomethyl)-8-methyl-1,4-methanodecahydronaphthalene, 1,5-, 2,5-, 1,6- and 2,6-bis(isocyanatomethyl)-4,7-methanohexahydroindane, 1,5-, 2,5- and 2,6-bis(isocyanato)-4,7-methanohexahydroindane, 2,4′- and 4,4′-dicyclohexyl diisocyanate, 2,4- and 2,6-hexahydrotolylene diisocyanate, perhydro-2,4′- and -4,4′-diphenylmethane diisocyanate, α,α′-diisocyanato-1,4-diethylbenzene, 1,3- and 1,4-phenylene diisocyanate, 4,4′-diisocyanatobiphenyl, 4,4′-diisocyanato-3,3′-dichlorobiphenyl, 4,4′-diisocyanato-3,3′-dimethoxybiphenyl, 4,4′-diisocyanato-3,3′-dimethylbiphenyl, 4,4′-diisocyanato-3,3′-diphenylbiphenyl, 2,4′- and 4,4′-diisocyanatodiphenylmethane, naphthalene 1,5-diisocyanate, 2,4- and 2,6-toluene diisocyanate, N,N′-(4,4′-dimethyl-3,3′-diisocyanatodiphenyl)uretdione, m-xylylene diisocyanate, dicyclohexylmethane diisocyanate, tetramethylxylylene diisocyanate, and the analogs and mixtures.

The polyol used for the preparation of the polyurethane can be a polyester, a polycaprolactone or a polyether. The polyesters result from the condensation of a diol with a dicarboxylic acid, generally adipic acid, or its derivatives, in particular diesters. Mention may be made, as example of polyester, of poly(butanediol adipate), poly(hexanediol adipate), poly(ethanediol/butanediol adipate), and the like. The polycaprolactones are polyesters resulting from the polymerization of (epsilon)-caprolactone and diols.

Mention may be made, as example of polyether, of poly(ethylene glycol) (PEG), poly(propylene glycol) (PPG), poly(tetramethylene glycol) (PTMG), and the like.

The short-chain diol which can be used for the preparation of the polyurethane can be hexanediol or butanediol, or an aromatic diol.

The polyurethane is advantageously a thermoplastic polyurethane.

According to a specific embodiment, the thermoplastic polyurethane is a linear polyurethane, that is to say that it is prepared from units each comprising at most two reactive functional groups capable of forming urethane bonds. In particular, all the units comprising isocyanate functional groups used in the preparation of the thermoplastic polyurethane are diisocyanates, with optionally monoisocyanates.

According to another embodiment, the thermoplastic polyurethane can exhibit a branched architecture, that is to say that it is prepared essentially from divalent units, with a small proportion of units exhibiting a greater valency (for example, triisocyanates), and optionally monovalent units (for example, monoisocyanates), the content of units with a valency of greater than 2 always being chosen in order for the thermoplastic polyurethane not to be crosslinked or, in other words, in order for it to remain meltable.

The polyurethane can be aromatic or aliphatic, for example as a function of the aromatic or aliphatic nature of the diisocyanate used to prepare it. Advantageously, the polyurethane of the invention is aliphatic. The polyurethane of the invention can be a blend of several different polyurethanes.

According to a specific embodiment of the invention, the polyurethane exhibits a number-average molar mass of greater than or equal to 2000 g/mol. Advantageously, it exhibits a number-average molar mass of greater than or equal to 5000 g/mol, preferably of greater than or equal to 10 000 g/mol and more preferably still of greater than or equal to 13 000 g/mol.

The compound U, in particular the polyurethane PU, can be present in the composition in a content ranging from 0.1% to 33% by weight, in particular from 0.5% to 20% by weight, especially from 1% to 11% by weight, very particularly from 2% to 6% by weight or indeed even from 2.5% to 5% by weight, with respect to the total weight of PA and of compound U.

Very particularly, the PA/compound U ratio by weight ranges from 2 to 1000, in particular from 4 to 200, especially from 8 to 100, very particularly from 15 to 50 or indeed even from 20 to 40.

The compound U, in particular the polyurethane PU, can be present in the composition in a content ranging from 0.1% to 20% by weight, in particular from 0.5% to 15% by weight, especially from 1% to 10% by weight and very particularly from 2% to 8% by weight, with respect to the total weight of the composition.

The reinforcing fillers are fillers having an effect of reinforcing the elastic modulus of the composition, in tension, in flexion and/or in compression, indeed even whatever the geometry in which the elastic modulus is measured. In other words, the composition comprising the reinforcing filler or fillers exhibits a greater elastic modulus than a composition in which the content by volume of reinforcing fillers is replaced by the polyamide of the composition.

These fillers can be provided in the form of spheres, in particulate form, in particular in the form of cubes or blocks, in the form of platelets, in acicular form or in the form of fibers.

The reinforcing fillers can exhibit a shape factor of greater than or equal to 1, in particular of greater than or equal to 5, especially of greater than or equal to 7 or indeed even of greater than or equal to 10.

Within the meaning of the present invention, the expression “shape factor” means the ratio of the greatest dimension characteristic of the shape of the filler to the smallest dimension characteristic of the shape of the filler, for example, in the case of the blocks, the length to the thickness, in the case of the platelets, the length to the thickness and, in the case of the fibers, the length to the diameter.

The particulate fillers can exhibit a shape factor ranging from 1 to 4, the platelet fillers a shape factor from 10 to 1000, the acicular fillers a shape factor from 3 to 30 and the fibrous fillers a shape factor from 10 to 150.

The fillers which can be used can be natural or synthetic. They can be chosen from:
fibrous fillers, such as glass fibers, carbon fibers, aramid fibers or natural fibers; mention may be made, among the natural fibers, of hemp and flax,
nonfibrous fillers, in particular spherical, particulate, platelet or acicular fillers and/or exfoliable or nonexfoliable nanofillers, such as glass microbeads, glass powder, calcium carbonate, kaolin, in particular calcined kaolin, zeolites, barite, mica, kaolinite, talc, graphite, molybdenum disulfide, wollastonite, nanocrystals, carbon nanotubes, alumina, silica, days, such as montmorillonite, zirconium phosphate, copper or diatomaceous earths, it being possible for these fillers to be used alone or as mixtures.

According to an alternative form, the reinforcing fillers are glass fibers. The glass fibers may or may not be sized, indeed may even be a mixture of sized glass fibers and of nonsized glass fibers.

The composition can comprise a content of reinforcing fillers of greater than or equal to 10% by weight, with respect to the total weight of the composition. In particular, this content ranges from 10% to 70% by weight, especially from 15% to 60% by weight or indeed even from 25% to 50% by weight, with respect to the total weight of the composition.

In addition, the composition can comprise additives of use for the subsequent preparation of the foam, such as surfactants, plasticizers, and the like. These additives are known to a person skilled in the art.

The composition can also comprise mattifying agents, such as titanium dioxide or zinc sulfide, pigments, dyes, heat or light stabilizers, bioactive agents, soil release agents, antistatic agents, flame retardants, high- or low-density fillers, and the like.

Very particularly, the composition is provided in the form of expandable granules. The latter can be obtained by processes as defined below.

Very particularly, the composition comprises, indeed even consists of:
at least one, in particular one, polyamide PA in a content ranging from 20% to 89.5% by weight, with respect to the total weight of the composition,
at least one, in particular one, compound U, in particular polyurethane PU, in a content ranging from 0.5% to 15% by weight, with respect to the total weight of the composition.
glass fibers in a content ranging from 10% to 70% by weight, with respect to the total weight of the composition, and
optionally additives, in particular as described above.

Very particularly, the PA/compound U ratio by weight in the composition ranges from 4 to 200, in particular from 8 to 100, very particularly from 15 to 50 or indeed even from 20 to 40.

In particular, the composition exhibits an apparent melt viscosity corresponding to the following relationships:

η100≦12.82(X)+239

η1000≦3.62(X)+139

in which η is the apparent melt viscosity of the polyamide composition, expressed in Pa·s and measured at a temperature 15° C. greater than the melting point of the polyamide composition, either at a shear rate of 100 s⁻¹, η100, or at a shear rate of 1000 s⁻¹, η1000, and X corresponds to the proportion by weight of additives heterogeneously dispersed in the polyamide matrix, with respect to the total weight of the composition.

The proportion by weight is expressed as % by weight, that is to say that, for a composition comprising, for example, 25% by weight of heterogeneously dispersed additives, the value of X is 25.

The apparent melt viscosity of the composition is measured by capillary rheometry according to the standard ISO 11443, in particular using a Göttfert Rheograph 2002 capillary rheometer. It is possible, for example, to use a capillary with a length of 30 mm and with a diameter of 1 mm.

If the measurement temperature is greater than 280° C., it will be possible to use an in-line rheometer composed of a capillary die fed from a single-screw extruder via a gear pump, in particular an At Line Rheometer (ALR) from Göttfert. In this case, a counterpressure chamber, also sold by Göttfert, can be added to the outlet of the capillary die of the ALR in order to be able to carry out the viscosity measurements at an outlet pressure greater than the critical solubility pressure of the gas in the molten polymer matrix, this being done in order to retain the single-phase composition throughout the measurement.

When the composition meets these relationships, the article obtained can exhibit a particularly good surface appearance.

Any method known to a person skilled in the art for preparing a composition can be used to prepare the composition of the invention comprising a polyamide PA, a compound U and a reinforcing filler. It is possible, for example, to carry out intimate mixing of the powders of the various compounds. It is also possible to introduce the compound U and/or the reinforcing fillers into the polyamide in the molten state. The mixing can, for example, be carried out in an extrusion device. The polyamide can also be provided in the form of granules comprising the reinforcing fillers, which are coated with the compound U.

The composition can be prepared in one or more stages. In particular, the polyamide, compound U and reinforcing filler components can be added at the same time or else separately.

When the composition is prepared using an extrusion device, for example, the composition can subsequently be shaped into granules. These granules can subsequently be used as is to prepare the foam starting from the composition.

According to a specific embodiment of the invention, the composition is prepared by introduction of the compound U, in particular polyurethane, and reinforcing fillers into the molten polyamide, the temperature of the medium being chosen so as to prevent any significant release of gas. Advantageously, the temperature T(° C.) for preparation of the composition of the invention is greater than or equal to Tₘ−30, preferably greater than or equal to Tₘ−20 and more preferably still greater than or equal to Tₘ−10, Tₘ being the melting point (in ° C.) of the polyamide PA of the composition. The temperature T(° C.) for preparation of the composition of the invention is preferably less than or equal to 275° C. In this case, the composition can be prepared in an extrusion device and can then be shaped into granules, for example. The granules obtained are expandable granules which can subsequently be introduced directly, for example, into a transforming and shaping device, in which the polyamide foam of the invention is prepared. Advantageously, the composition of the invention before stage a) is in the form of expandable granules.

The temperature to be achieved during the heating stage a) of the process of the invention has to be sufficient for there to be formation of gas, generally carbon dioxide. The gas formed originates in particular from the reaction between the isocyanate functional groups, resulting from the decomposition of the urethane functional groups, and the carboxylic acid functional groups of the polyamide of the composition. It also originates from the reaction between the isocyanate functional groups and the water present in the composition. The temperature and the kinetics of the reactions bringing about the release of gas are in particular dependent on the nature of the various constituents of the composition, that is to say of the compound U, the polyamide and the reinforcing fillers and on the presence or absence of catalysts.

The temperature to be achieved during the heating stage a) is greater than or equal to the melting point of the polyamide PA of the composition. Advantageously, this temperature T′(° C.) is greater than or equal to T(° C.)+10, preferably greater than or equal to T(° C.)+15, T(° C.) being the temperature for preparation of the composition of the invention, described above. In particular, this temperature is greater than 280° C.

Stage a) is generally carried out in the molten state. A device for transforming plastic, such as an extrusion or injection molding device, can be used during this stage. The duration of stage a) varies according to the device used. It is possible to employ, during this stage, a catalyst or a mixture of catalysts.

A catalyst can be used to accelerate the decarboxylation reaction of the acid and carbamic acid anhydride obtained by reaction of the acid functional group with the isocyanate functional group; mention may be made, by way of example, of tertiary amines, such as diazabicyclooctane (DABCO), diazabicycloundecene (DBU) or triethylamine.

The preparation of the composition of the invention and the preparation of the foam from this composition can be carried out simultaneously. They can be carried out in identical devices, such as an extrusion or injection molding device.

During stage a), surfactants and also plasticizers can be introduced. Other compounds can also be introduced during stage a), such as mattifying agents, such as titanium dioxide or zinc sulfide, pigments, dyes, heat and/or light stabilizers, bioactive agents, soil release agents, antistatic agents, flame retardants, and the like.

This stage a) thus makes possible the generation of gas, in particular CO₂, via chemical reactions. The pressure during this stage is such that the gas remains in solution in the polyamide or in the polymer matrix, which is molten. During the passage from the die, in extrusion, or the injection of the composition into the mold, in injection molding, the pressure decreases, which results in the formation of gas bubbles and thus creates a two-phase system. The growth of the gas bubbles can be halted by the increase in viscosity of the polymer, in particular up to solidification, in particular due to the cooling of the composition.

In particular, stage a) is carried out at a pressure greater than the critical solubility pressure of the gas, in particular CO₂, in the molten polymer matrix, in particular at a pressure greater than 10 bar, indeed even than 20 bar. For its part, stage b) can be carried out at a pressure lower than this pressure and in particular a pressure of less than 10 bar.

The cooling of the composition subsequent to stage b) can be carried out by contact with a heat-exchange fluid, in particular air or water, or with a metal wall, in particular a mold or a sizing die, according to whether extrusion or injection is concerned. In particular, the cooling in order for the article to be fully solid can be carried out in less than 120 seconds, in particular less than 60 seconds, especially less than 30 seconds, very particularly less than 20 seconds and indeed even less than 15 seconds.

For the semicrystalline polyamides, the cooling time in order for the article to be fully solid corresponds to the time necessary for the temperature at the core of the article to be less than the crystallization temperature of the semicrystalline polyamide. In other words, it may be the time in order for all the parts of the article to be at a temperature lower than the crystallization temperature of the semicrystalline polyamide.

For the amorphous polyamides, the cooling time in order for the article to be fully solid corresponds to the time necessary for the temperature at the core of the article to be less than the glass transition temperature of the amorphous polyamide. In other words, it may be the time in order for all the parts of the article to be at a temperature lower than the glass transition temperature of the amorphous polyamide.

The process of the invention thus provides a simple method for producing reinforced foamed polyamide articles. This is because such articles can be easily obtained according to conventional conditions for the melt transformation of aliphatic polyamides, such as polyamide 66, and/or semi-aromatic polyamides, and using conventional equipment. Furthermore, the foam can be obtained in situ without requiring the introduction of external compounds, in particular additional pore-forming agent or reinforcing fillers, and directly from the composition and more particularly from expandable granules of this composition. Finally, this process, in particular by the use of polymeric materials (polyurethane and polyamide) and of reinforcing fillers, makes it possible to obtain articles exhibiting good mechanical properties.

Moreover, in particular, the process is devoid of a supplementary stage of addition of reinforcing fillers, in particular subsequent to stage a).

The expandable granules can exhibit a fine dispersion of compound U in the polyamide matrix, which results in a particularly homogeneous generation of gas in the polymer and in the ready dissolution of the gas in the molten polymer during stage a).

Said process according to the invention can also make it possible to obtain a maximum degree of foaming, in particular in injection molding, greater by at least 30% with respect to a process in which the foaming is carried out without the presence of reinforcing fillers and in particular of glass fibers. In the case of a rapid rate of injection, this maximum degree of foaming can even be increased by 400%,

The degree of foaming being (expressed as %)=100*[1−(weight of the foamed part/weight of a nonfoamed part having the same volume)].

The process according to the invention can make it possible to obtain articles exhibiting a density reduced by at least 10%, in particular by at least 15% and indeed even by at least 20%, with respect to a nonfoamed article.

The articles capable of being obtained according to the process of the invention exhibit a “dosed porosity” structure, that is to say that the polymer matrix is the only continuous phase of the system and the gas is present in the form of discrete bubbles.

The process can also make it possible to obtain articles, the water absorption of which is reduced in comparison with that of the polyamide additivated with the reinforcing fillers of the composition. This value can be measured according to the standard ISO 1110.

The articles obtained can have improved thermal insulation characteristics, that is to say a thermal conductivity reduced by at least 10%, indeed even by at least 15% and in particular by at least 20%, with respect to an equivalent nonfoamed article. This thermal conductivity can be measured according to the standard ASTM-1114-98.

The articles obtained can be foamed in the form of structural foams, that is to say rigid foams composed of a core of lower density and of a skin, the density of which is similar to that of the nonfoamed composition.

In these articles, the increase in the size of the bubbles can be due essentially to two phenomena: (1) the diffusion of the gas, initially dissolved in the polyamide matrix, from the polyamide matrix toward the bubble and (2) the coalescence of two or more bubbles having a diameter of greater than 1 μm.

The process can make it possible to obtain articles in which the diameter of the gas bubbles resulting directly from the diffusion of the gas from the polyamide matrix toward the bubble is less than 250 μm, in particular than 150 μm, especially than 100 μm or indeed even than 60 μm, at the core.

The size distribution of the population of gas bubbles resulting directly from the diffusion of the gas from the polyamide matrix toward the bubble can be determined by tomography, in particular by X-ray tomography; in the case where several populations exist, it corresponds to the population of gas bubbles of smallest size, the maximum diameter of which is taken into account.

The process can make it possible to obtain articles having a content of at least 98% by number, indeed even at least 99% by number, of bubbles, the diameter of which is less than 250 μm, in particular than 150 μm, especially than 100 μm or indeed even than 60 μm, at the core.

This content of bubbles with a diameter less than the reference diameter can be estimated according to the following protocol on a standardized article:
a polyamide composition, in particular as defined in the present description, optionally in the form of granules, is injection molded in a press equipped with a shut-off nozzle and with the mold described in example 3,
a bar with a width of 1.5 cm is cut out from the entire length of a molded disk thus obtained, the bar being centered on the diameter passing through the injection point and the center of the disk,
the section of the bar located at the center of the disk is removed and polished,
observation of this section by scanning electron microscopy is carried out with a magnification of 25, so as to see the entire thickness of the disk on the micrograph,
the percentage by number of bubbles having a diameter greater than the reference diameter is determined by multiplying by 100 the ratio of the number of bubbles having a diameter greater than the reference diameter over the entire surface of the micrograph to the total number of bubbles having a diameter greater than 5 μm over the entire surface of the micrograph.
the content of bubbles with a diameter less than the reference diameter, expressed as percentage, is finally obtained by the formula: ‘100-percentage by number of bubbles having a diameter greater than the reference diameter’.

This protocol is repeated 5 times in order to obtain a mean value of this percentage.

The articles according to the invention, in particular capable of being obtained according to the process of the invention, can be articles for the motor vehicle industry, electrical or electronic components or also accessories for sports activities. In particular, these articles are used in applications requiring good resistance to heat, a saving in weight, high mechanical strength, in particular in temperature, and/or good barrier properties.

The examples below are presented by way of illustration of the invention.

### EXAMPLES

The contents of acid end groups and amine end groups of the polyamides are assayed by potentiometry. AEG means: amine end groups; CEG means: carboxylic acid end groups.

The Viscosity Numbers (VN) of the polyamides are measured starting from a 0.5% solution of polymer dissolved in 90% formic acid, according to the standard ISO EN 307.

### Example 1

### Manufacture of Expandable Granules Reinforced with Glass Fibers

The compounds used are as follows:
69/31 weight/weight PA/glass fibers composition: this polyamide composition reinforced with glass fibers was prepared from polyamide 66 having a VN of 138 m/g and end group contents AEG=56 meq/kg, CEG=74 meq/kg, and glass fibers for extrusion having a diameter of 10 μm. The glass fibers are homogeneously distributed in the polyamide of this composition. The mean length of the glass fibers in the composition is μm and its water content is 1000 ppm.
PA: Polyamide 66 having a VN of 138 ml/g and comprising 1000 ppm of water. Contents of end groups: AEG=56 meq/kg, CEG=74 meq/kg.
PU: Aliphatic thermoplastic polyurethane based on ε-caprolactone (epsilon-caprolactone) sold under the name Krystalgran PN03-214 by Huntsman.

The compositions are prepared by melt blending, using a corotating twin-screw extruder of Thermo Prism model TSE16TC type, exhibiting a diameter of 16 mm and a length/diameter ratio equal to 25. All the compounds are added at the start of the extruder. The compositions prepared are shown in table 1 as percentage by weight in the composition. The extrusion conditions are described in detail in table 2. The compositions extruded are cooled in water at ambient temperature and cut up into the form of granules.

TABLE 1

| | Composition 1 | Composition 2 |
|---|---|---|
| 69/31 weight/weight PA/glass fibers | 93 | 93 |
| composition | | |
| PA | 3.5 | 7 |
| PU | 3.5 | 0 |

TABLE 2

| | Composition 1 | Composition 2 |
|---|---|---|
| Set point temperature profile in the | 255(die)-250-250- | 255(die)-250-250- |
| extruder (° C.) | 255-260 | 260-255 |
| Temperature of the molten | ≦267 | ≦272 |
| polymer in the | | |
| extruder (° C.) | | |
| Rotational speed (revolutions/min) | 407 | 407 |
| Throughput (kg/h) | 3.8 | 3.5 |

In total, composition 1 comprises a PA/PU/glass fibers ratio of 68/3.5/28.5 weight/weight/weight. The PA/PU ratio is 95/5 weight/weight therein. Composition 2 comprises a PA/glass fibers ratio of 71.5/28.5 weight/weight. The PA/PU ratio is 100/0 weight/weight therein.

### Example 2

### Manufacture of Expandable Granules Reinforced with Glass Fibers

The compounds used are as follows:
Composition 1 described in example 1 comprising 1000 ppm of water.
Composition 2 described in example 1 comprising 1000 ppm of water.

Composition 3 is prepared in the molten phase, using a corotating twin-screw extruder of Thermo Prism model TSE16TC type, exhibiting a diameter of 16 mm and a length/diameter ratio equal to 25, by blending compositions 1 and 2 in a 40/60 weight/weight ratio. Compositions 1 and 2 are added at the start of the extruder. The extrusion conditions are described in detail in table 3. The compositions extruded are cooled in water at ambient temperature and cut up into the form of granules.

TABLE 3

| | Composition 3 |
|---|---|
| Set point temperature profile in the extruder (° C.) | 255(die)-250-250- |
| | 260-260 |
| Temperature of the molten polymer in the extruder | ≦272 |
| (° C.) | |
| Rotational speed (revolutions/min) | 400 |
| Throughput (kg/h) | 3.0 |

In total, composition 3 comprises a PA/PU/glass fibers ratio of 70/1.5/28.5 weight/weight/weight. The PA/PU ratio is 98/2 weight/weight therein.

### Example 3

### Manufacture of Expanded Articles Using an Injection Molding Device

The foaming of the expandable granules of examples 1 and 2 is carried out in the molten phase using an Arburg Allrounder 220D 350-90 injection molding machine (screw diameter: 30 mm, L/D=15, maximum clamping force 350 kN) equipped:
with a shut-off nozzle with a diameter of 3 mm and
with a mold system comprising Axxicon AIM™ inserts into which the ‘AIM insert disk’ insert, corresponding to two disks with a diameter of 85 mm and with a thickness of 3 mm and modified so as to direct the material stream only into a single disk, has been introduced. This insert exhibits vent regions evenly distributed over the perimeter of the disk and a single injection point located on the edge of the disk.

The injection conditions and the densities obtained are summarized in table 4.

TABLE 4

| | Injection test | | | |
|---|---|---|---|---|
| | Test 1 | Test 2 | Test 3 | Test 4 |
| Composition | Composition 1 | Composition 1 | Composition 3 | Composition 2 |
| Water content | 1000 | 1000 | 1000 | 1000 |
| before foaming | | | | |
| (ppm) | | | | |
| Temperature profile | 278(nozzle)- | 280(nozzle)- | 277(nozzle)- | 289(nozzle)- |
| (° C.) | 312-311-290 | 310-310-290 | 310-312-289 | 289-289-284 |
| Cycle time (s) | 39.9 | 39 | 39.9 | 39.4 |
| Injection rate | 99 | 105 | 56 | 62 |
| (cm³/s) | | | | |
| Injection time (s) | 0.42 | 0.33 | 0.52 | 0.55 |
| Mold temperature | 90 | 90 | 90 | 80 |
| (° C.) | | | | |
| Weight of the lift (g) | 18.6 | 18.3 | 19.7 | 24.5 |
| Reduction in weight | 24% | 25% | 20% | 0% |
| with respect to test 4 | | | | |

In tests 1, 2 and 3, the cell distribution is of closed type. A core-skin structure typical of a structural foam is observed, with very few cells under the skin and, at the core, cells with a diameter of less than 90 μm for tests 1 and 2 and less than 200 μm for test 3.

In particular, FIG. 1 represents a scanning electron microscopy view in cross-section of the entire thickness of a foamed disk corresponding to test 1. More specifically, a bar with a width of 1.5 cm is cut out from the entire length of a molded disk obtained in test 1, the bar being centered on the diameter passing through the injection point and the center of the disk. The section of the bar located at the center of the disk is removed and polished. Observation of this section by scanning electron microscopy is carried out with a magnification of 25, so as to see the entire thickness of the disk on the micrograph.

### Example 4

### Properties of the Expanded Disks of Test 2

The properties of the disks of test 2 are summarized in the following table 5.

TABLE 5

| | Injection test |
|---|---|
| | Test 2 |
| Composition | Composition 1 |
| Reduction in weight with | 25% |
| respect to test 4 | |
| Reduction in thermal | 23% |
| conductivity with | |
| respect to test 4 | |
| Reduction in water | 15% |
| absorption with respect | |
| to test 4 | |

The measurements of thermal conductivity are carried out on dry parts, such as outputs from the injection molding process. The thermal conductivity is expressed in W/m·K, and the water absorption measurements are carried out according to the standard ISO1110. The water absorption is expressed as percentages by weight.

These measurements dearly demonstrate an improvement both in the properties of thermal insulation and of reduction in water absorption, while having a saving in weight and while using a process which is very simple to carry out.

1. A process for the preparation of a foamed article comprising the following stages:
a) heating a composition comprising:
at least one polyamide PA,
at least one compound U, said compound U comprising at least one urethane functional group,
at least one reinforcing filler, the content of reinforcing fillers being greater than or equal to 10% by weight, with respect to the total weight of the composition,
to a temperature T such that:
the compound U generates, directly or indirectly, CO₂ and
the polyamide is molten,
b) injecting or extruding said composition;
c) recovering the foamed article.

2. The process according to claim 1, wherein the reinforcing fillers are chosen from the group consisting of:
fibrous fillers, and
nonfibrous fillers.

3. The process according to claim 2, wherein the reinforcing fillers are blocks, platelets, acicular fillers, and/or fibers.

4. The process according to claim 1, wherein the reinforcing fillers are chosen from the group consisting of glass fibers, which may or may not be sized, a mixture of these, carbon fibers and acicular fillers.

5. The process according to claim 1, wherein the composition comprises a content of reinforcing fillers ranging from 10% to 70% by weight, with respect to the total weight of the composition.

6. The process according to claim 1, wherein the polyamide of the composition exhibits a number-average molar mass Mn of greater than or equal to 10 000 g/mol.

7. The process according to claim 1, wherein the polyamide of the composition exhibits a number-average molar mass Mn of less than or equal to 35 000 g/mol.

8. The process according to claim 1, wherein the polyamide of the composition is chosen from the group consisting of polyamide 6, polyamide 6,6, polyamide 11, polyamide 12, polyamide 4,6, polyamide 6,10, polyamide 10,10, polyamide 12,12, polyamide 10,12, polyamide 6,36 and their copolymers; semi-aromatic polyamides, MXD6, polyphthalamides obtained from terephthalic acid and/or isophthalic acid, and their copolyamides, copolyamide 66/6T, copolyamide 6T/6I, polyamides and copolyamides based on 6T, 9T and 10T, and their copolymers and alloys.

9. The process according to claim 1, wherein the polyamide PA is present in the composition in a content ranging from 20% to 89.9% by weight, with respect to the total weight of the composition.

10. The process according to claim 1, wherein the CO₂ generated originates, to at least 80% by volume, from reactions involving, directly or indirectly, the compound U.

11. The process according to claim 1, wherein the compound U is a polyurethane PU, or a compound of the polyisocyanate blocked by an alcohol or a phenol type.

12. The process according to claim 1, wherein the composition comprises a content of compound U, ranging from 0.1% to 33% by weight, with respect to the total weight of PA and of compound U.

13. The process according to claim 1, wherein the PA/compound U ratio by weight ranges from 2 to 1000.

14. The process according to claim 1, wherein stages a) and b) are carried out by injection molding.

15. The process according to claim 1, wherein the composition is in the form of expandable granules.

16. The process according to claim 1, wherein the article exhibits at least 98% by number of bubbles, the diameter of which is less than 250 μm.

17. The process according to claim 1, wherein the composition exhibits an apparent melt viscosity corresponding to the following relationships:
η100≦12.82(X)+239
η1000≦3.62(X)+139
in which η is the apparent melt viscosity of the polyamide composition, expressed in Pa·s and measured at a temperature 15° C. greater than the melting point of the polyamide composition, either at a shear rate of 100 s⁻¹, η100, or at a shear rate of 1000 s⁻¹, η1000, and X corresponds to the proportion by weight of additives heterogeneously dispersed in the polyamide matrix, with respect to the total weight of the composition.

18. An expandable granule, comprising:
at least one polyamide,
at least one compound U, said compound U comprising at least one urethane functional group, and
at least one reinforcing filler, the content of reinforcing fillers being greater than or equal to 10% by weight, with respect to the total weight of the composition.

19. (canceled)

20. A foam or a foamed article obtained by the process according to claim 1.

21. A method for improving the control of the size of the bubbles present in a foamed article, the method comprising using reinforcing fibers.
